(19) United States
(12) Patent Application Publication
(10) Pub. No.: US 2019/0182838 A1
(43) Pub. Date: Jun. 13, 2019

(54) Arrangement and method for dynamic quota allocation in communication network

(71) Applicant: Comptel Oy, Helsinki (FI)

(72) Inventor: Yevgeniy Bondarenko, Helsinki (FI)

(73) Assignee: Comptel Oy, Helsinki (FI)

(21) Appl. No.: 15/837,054

(22) Filed: Dec. 11, 2017

(30) Foreign Application Priority Data
Dec. 11, 2017 (FI) 20176103

(51) Int. Cl. H04W 72/04

(52) U.S. Cl. CPC H04W 72/0486

(57) ABSTRACT

Electronic arrangement for dynamically reserving quota having regard to the capacity of one or more resources available in a communications network, comprises one or more data interfaces such as transceivers for transferring data, at least one processor for processing instructions and other data, and memory for storing the instructions and other data, said at least one processor being configured, in accordance with the stored instructions, to cause: receiving a quota request with indication of a requested extent of quota, wherein the quota request is further associated with all-or-none preference indicator as to whether the request should be fulfilled completely, obtaining an indication of a currently remaining, unused and unreserved, quota of an account associated with the quota request, determining whether and to which degree, including in full, in part and not at all, the request may be granted in terms of reserving the requested quota based on at least the requested extent, the remaining quota and the preference indicator, wherein the indicator is utilized in the determination so that indicated preference on complete fulfillment of quota request translates into reduced criterion in quota allocation and vice versa, and providing a response to the quota request indicative of extent of granted, reserved quota, if any, where the response optionally refers to a signaling message. A corresponding method for reserving quota is presented.

### FIELD OF THE INVENTION

The present invention generally relates to an electronic arrangement and related method for allocating network resources for use by a number of users via terminal devices. Particularly, however not exclusively, the invention pertains to optimized allocation of network resources dynamically e.g. in multi-session and multi-user contexts.

### BACKGROUND

In the realm of communication networks, concerned devices, services and processes, usage of related resources is usually controlled in a variety of ways as they are simply not unlimitedly available in terms of e.g. required processing, memory or communication capacity, or induced costs. Instead, operating the networks and supporting or running the associated services requires a surprising amount of costly, technically complex hardware as well as maintenance work, which cannot be normally up-scaled freely e.g. for “safety's sake” upfront or always even upon need. Instead, the available resources are to be allocated more analytically based on the established prioritization schemes taking e.g. service subscriptions of users into account in the procedure.

For a single subscriber or a subscriber account, which can be associated with one end user only, or alternatively, a plurality of end users with reference to e.g. a family account or a corporate account, a certain initial balance allowing the use of such resources may be determined in a user subscription. The initial balance may define the overall initially available quota, i.e. allocable capacity, in terms of e.g. the amount of data in selected units such as bytes, kilobytes, megabytes or gigabytes the particular subscription in question entitles to transfer. Quite commonly, the quota also has a temporal dimension; for example, the same initial overall quota or balance may be reissued (re-initialized) for each new subscription-defined time period, such as one month, which may be again stipulated by the subscription details such as a related service plan. Additionally or alternatively, the use of resources may be directly controlled in a temporal fashion, if e.g. the balance/remaining overall quota is determined by the number of time units or time duration the subscription is allowed to spend with a target resource such as a target service. Yet, the balance may be associated with further measurable events, not or not at least solely defined by the amount of data transferred or time consumed, wherein the events may include a number of service accesses, interactions, downloads, uploads, other service related tasks, etc. Yet, the balance could be directly or implicitly linked to finances such as credit in some selected generally recognized and adopted currency (e.g. national or regional), digital currency, proprietary currency or other units.

Notwithstanding the nature of units considered (time, events, data, etc.) in each potential resource management scenario, to control the allocation of resources an applicable capacity reservation mechanism, i.e. quota allocation mechanism, is to be implemented to avoid e.g. sudden exhaustion or over-usage of resources. Accordingly, quota type of share may be allocated gradually and in smaller units than the overall remaining balance available to the concerned subscriber.

Therefore, an entity operable in the network, such as an application running in a user terminal, may first send a quota request to a resource manager entity such as PCC (policy and charging control) architecture, or specifically, a PCRF (policy charging and rule function) node of a communication network in question, which then decides upon whether to allocate the requested quota, reject the request or execute some other measure in response based on e.g. existing (account) balance of a related service subscription.

When the quota is allocated, the respective resources are reserved, i.e. put at least temporarily aside, from the balance for subsequent use by the requestor. Whether the resources are ultimately used, e.g. at all or in full, still remains a question. A proper design and implementation of applied quota allocation mechanism has many implications having regard to QoS, use experience, service and network operator satisfaction, etc.

For example, a certain service generally subjected to the resource management and quota allocation policies utilized in the network may be associated with a service usage threshold in view of the resources. Responsive to reaching or exceeding the threshold, selected action(s) such as throttling, redirecting, and/or other campaign or policy control measures may be executed by an operator. However, the operator may not desire to trigger the application of such policy before the full quota has actually been used, since it might cause bad use experience (service is throttled or cut off from the subscriber), also not forgetting e.g. associated financial losses. Therefore, one approach is to grant fixed amounts of quota and so-called ‘last piece’ when closing to the threshold (limit).

However, if fixed quota size is relatively large, e.g. multi-session users and family/corporate users may not be able to establish more sessions (by “late” users) because of all available quota already granted to earlier sessions and/or users.

This turns easily into even a bigger problem in the case of network hardware failures or restarts when earlier granted quota is not duly returned (user sessions are lost) to the balance pool wherefrom it was originally allocated. In this case the reserved but ultimately unused quota should naturally be released asap, but it may take for a long time if happen at all, since in many network environments and related use contexts user sessions can last for days, which has various implications. For example, throttling or connection cut-off may occur while not all balance was actually depleted due to unnecessarily hanging existing reservations.

In contrast, if the fixed quota size is small, it may be technically unmeaningful in a sense that in the concerned device or service context, it does not practically suffice for any reasonable or at least primarily intended utilization of the concerned resources, or even for monitoring and enforcing the use if the resolution of monitoring/enforcing equipment is coarser. The amount of signalling overhead in the system may further increase greatly, dealing with requiring more network capacity, which also affects the end users very tangibly and negatively by, for example, causing additional latency during VoIP (Voice over IP), or specifically e.g. VoLTE (voice over LTE), calls. Technical handling and approval of continuous, small quota requests is just slow due to associated signaling and processing. A modern user or subscription (account) may be associated with a great number of simultaneous ongoing sessions and even a single session may involve multiple traffic types “eating from the same bucket”, i.e. balance, whereupon a solution addressing the above challenges would be highly appreciated.

### SUMMARY

The objective of the present invention is to provide a solution at least alleviating one or more of the aforesaid defects and drawbacks associated with prior art arrangements in the context of communication networks, such as mobile communications networks, and related control mechanisms for practical quota allocation especially, but not exclusively, in connection with multi-session users or multi-user subscriber accounts.

The objective is achieved by various embodiments of an arrangement and a method as defined in the appended claims.

In accordance with an aspect of the present invention, an electronic arrangement, such as a server or a system of multiple connected servers, for dynamically reserving quota having regard to the capacity of one or more resources available in a communications network such as a mobile or generally wireless communications network, optionally 4G or specifically LTE based network, or 5G network, comprises one or more data interfaces such as transceivers for transferring data, at least one processor for processing instructions and other data, and memory for storing the instructions and other data, said at least one processor being configured, in accordance with the stored instructions, to cause:

receiving a quota request, such as a signaling message, with indication of a requested extent of quota, such as requested bandwidth with reference to data rate and/or amount of data transfer with reference to size thereof, wherein the quota request is further associated with, and optionally incorporating, all-or-none preference indicator as to whether the request should be fulfilled completely (and conversely, could the request be granted only in part, i.e. a resulting more limited quota would still likely turn out useful),

obtaining an indication of a currently remaining, both unused and unreserved, i.e. free, quota of an account associated with the quota request preferably based on the corresponding initial overall quota (i.e. initial balance), already-consumed quota (subtraction of such already-consumed quota or balance from the initial balance/initial overall quota thus handing out current balance) and currently reserved quota,

determining whether and to which degree, including in full, in part and not at all, the request may be granted in terms of reserving the requested quota based on at least the requested extent, the remaining quota and the preference indicator, wherein the indicator is utilized in the determination so that indicated preference on complete fulfillment of quota request translates into reduced criterion or criteria in quota allocation and vice versa, and

providing a response to the quota request indicative of extent of granted, reserved quota, if any, where the response is optionally provided in a signaling message.

In various embodiments, the preference indicator may be account, session and/or request-specific (such as request-indicated or request-contained using e.g. related indicator field or flag in the associated request message).

In various embodiments, the extent of (granted) quota having regard to the requested resources may be determined and/or indicated in selected units such as time units (e.g. seconds, minutes, days, months), bandwidth such as data rate (e.g. megabits per second), number of events (e.g. service accesses, downloads), or amount or volume of data (e.g. kilobytes, megabytes, gigabytes, terabytes).

Yet, in some embodiments, a translation mechanism (e.g. conversion formula or table), optionally offered e.g. by a rating function, may be utilized in converting or generally processing the data in the request indicative of the requested extent of quota to make it commensurate with account related data (or vice versa) available regarding the remaining quota and/or balance of the subscription account.

In various embodiments, the arrangement is configured to overbook (exceed) the remaining quota associated with the account in terms of one or more reservations, i.e. to allow reservation(s) going beyond the remaining quota, preferably limited by a selected, optionally dynamically alterable, amount, which may be in turn stipulated by extent variable such as size variable. Additionally, overbooking may be further controlled e.g. in binary fashion (on/off) by another variable or generally indicator, which may be dynamically alterable. The variable(s) may be subscriber/account-specific.

In various embodiments, the quota reservation, such as the extent of the granted quota, may be further determined based on a multi-session variable regarding and potentially indicative of a number of e.g. potential or actual parallel quota consuming sessions associated with the account. Greater number of sessions may translate into reduced extent and vice versa according to a selected, optionally dynamically adjustable or adapting, decision criterion and related decision logic.

In various embodiments, the quota reservation may be further determined based on a selected, e.g. predefined, minimum reservable (allowed) quota below which the extent of reserved quota granted responsive to the quota request shall not descend, or at least such grants should be preferably avoided/minimized. Thus, in a typical scenario such minimum is to be granted unless the request is denied completely, i.e. no reservation is made. The minimum may be defined by a variable (value) that is optionally dynamically alterable and/or adaptive.

By utilizing such minimum, grants of basically meaningless crumbs of quota (e.g. so small that the requesting entity cannot utilize them) may be minimized or avoided and e.g. such surplus quota be combined with other reservations that could really make use out of it. The minimum value may be selected utilizing e.g. known hardware or software limits and common sense. For example, making one byte available for data transfer makes nowadays usually no sense in the context of modern communications or specifically mobile networks as the amount is so small it cannot be really used for conveying any decent amount of typical service data.

Thus in the light of foregoing, in various related embodiments, when the remaining quota does not cater for the requested extent plus one more minimum reservable quota as discussed above, the whole remaining quota may be granted.

Yet, in various embodiments, if the amount of remaining quota is actually already smaller than minimum reservable quota, which may happen due to various factors such as partial return, or recovery, of already once granted quota, and if overbooking is not allowed (as indicated by the associated indicator, for example, as discussed above), the whole remaining quota may still be granted (reserved) responsive to the request.

Further, in some embodiments, in a scenario otherwise similar to the above one except the overbooking status (now allowed), the minimum reservable quota could be granted, utilizing overbooking.

In various embodiments, if current balance (unused quota) is zero or less (due to e.g. overbooking that realized in over-usage of the reserved resources as well), any new reservation request shall be, by default, rejected.

In various embodiments, upper allowable limit of the quota reservation may be set to be dynamic and correspond e.g. to the current balance. That means that even if based on other determinations more quota was to be granted, it would still be limited to the current balance.

In various embodiments, an entity such as an external system or e.g. user device may be provided with a notification sent thereto, informing the recipient about the balance and/or remaining quota approaching, hitting, or exceeding a selected limit. The notification may refer to a separate message or it may be integrated, as a flag, in the response.

In various embodiments, configuration information for a quota allocation mechanism may be stored e.g. in the memory to be fully or selectively fetched upon execution of the quota allocation process suggested herein.

In accordance with another aspect of the present invention, a method for dynamically reserving quota having regard to the capacity of one or more resources available in a mobile communications network, comprising:

receiving a quota request with indication of a requested extent of quota, wherein the quota request is further associated with all-or-none preference indicator as to whether the request should be fulfilled completely,

obtaining an indication of a currently remaining, unused and unreserved, quota of an account associated with the quota request, which may be again, as above, calculated by subtracting current quota reservations from current balance,

determining whether and to which degree, including in full, in part and not at all, the request may be granted in terms of reserving the requested quota based on at least the requested extent, the remaining quota and the preference indicator, wherein the indicator is utilized in the determination so that indicated preference on complete fulfillment of quota request translates into reduced criteria in quota allocation and vice versa, and providing a response to the quota request indicative of extent of granted, reserved quota, if any.

Various considerations presented herein concerning the embodiments of the arrangement may be flexibly applied to the embodiments of the method mutatis mutandis, and vice versa, as being readily appreciated by a person skilled in the art.

The utility of the present invention that is generally based on dynamically determined, optimized quota reservation, is basically a result of many contributing factors depending on each particular embodiment. Duly optimized reservations are utilized to enable that a subscriber's account does have enough quota for usage with a number of potentially parallel, ongoing sessions relating to different applications, services, etc. Adaptive intelligence is provided to the reservation mechanism to be able to serve multiple reservation clients and avoid e.g. unnecessary lockouts arising from the reservation of all available quotas. The suggested solution generally adapts very well into different multi-user or multi-session (by one or more users) scenarios and enables optimized sharing of common quota for network resource usage.

Various embodiments of the present invention find many uses e.g. in connection with communication networks, such as mobile networks (3G, 4G/LTE, 5G etc.), and related online allocation of resources through a reservation mechanism. The embodiments may be conveniently at least functionally connected to, or integrated with, one or more existing network entities such as OCS (online charging system) or other selected element of PCC (Policy and Charging Control) architecture generally provided e.g. for QoS and/or charging control in the network, such as a PCEF (Policy and Charging Enforcement Function).

Accordingly, in preferred embodiments the extent (or practically “size”, also being equally appropriate term in many use contexts and resources to be reserved) of a quota reservation issued in response to a quota request is made dependent, besides on the requested extent and current balance minus potential already issued reservations (i.e. remaining quota), on a so called all-or-none (all-or-nothing) type information optionally obtained in connection with the request itself from a requestor or intermediate entity.

The all-or-none data may indicate whether the size or generally extent of a requested reservation can be altered, in practice specifically decreased, while potentially still being valuable from the standpoint of intended quota usage. Granting a larger quota than originally requested is usually not an issue to the requestor and may result from e.g. otherwise minimal remaining leftover quota that could not be sensibly utilized or processed such as enforced in isolation anymore. However, in certain contexts the value of an all-or-none indicator may conveniently indicate to the quota determination mechanism that lesser than the requested extent of quota is potentially not useful at all, considering e.g. a situation wherein a message such as a long textual message (e.g. SMS, short message service), should be transferred and granted quota allocations of less than the requested capacity may not thus have any value to the requestor as the message could not be transferred in full. In response to the value of the indicator, the quota allocation mechanism may adjust quota allocation policy applied and at least relatively increase, for instance, the granted quota e.g. generally or in a number of selected scenarios when the need for full requested quota has been signaled in contrast to cases where the indicator shows that also partial grant may bear value.

In addition, the extent of a quota reservation may be subjected to a selected and potentially dynamically adjustable or adaptive minimum extent allowed to reservations (that may be strictly followed or utilized more as a guideline, depending on the embodiment) so that the minimum extent at least in most cases remains within practically useful limits. For example, if policy controlling or executing entity such as a PCEF (Policy and Charging Enforcement Function) cannot operate with a certain small extent, there is no sense in granting such quota reservation in the first place.

Furthermore, multi-session or multi-user information may be utilized to control quota allocation. A multi-session factor, e.g. variable in a memory having a value assigned therewith, can be selected upfront (predefined) and possibly updated manually upon need only, or be automatically determined dynamically according to selected logic and thus be rendered adaptive based on a number of session-related data. For instance, analytics regarding e.g. resource(s) such as service(s) usage by the concerned user(s) or generally by the underlying subscription/account), may be utilized in determining the multi-session based control factor.

Still further, overbooking such as doublebooking the quota in terms of reservations may be allowed and e.g. the amount of overbooking controlled, optionally dynamically and adaptively. As contemplated hereinbefore, as quite often not all the reserved quota is ultimately used, enabling overbooking does not necessarily induce additional stress to the resources utilized or cause financial losses to the network or service operator, or other party dealing with the overbooking costs, while it may considerably elevate the user experience. By properly determining e.g. the amount of tolerable overbooking in favor of enhanced user experience, also the risk level associated with actually realized over-usage of resources (e.g. how much to overload the technical resources and/or how much to lose financially in a worst case scenario), not just reservation of such, may still be flexibly controlled.

Additional benefits and implications having regard to different embodiments of the present invention are discussed hereinlater in the detailed description.

The expression “a number of” may herein refer to any positive integer starting from one (1).

The expression “a plurality of” may refer to any positive integer starting from two (2), respectively.

Different embodiments of the present invention are disclosed in the attached dependent claims.

### BRIEF REVIEW OF THE DRAWINGS

Few embodiments of the present invention are described in more detail hereinafter with reference to figures, in which

FIG. 1 illustrates an embodiment of an arrangement in accordance with the present invention and potential related use scenario.

FIG. 2 is a block diagram representing the internals of an embodiment of an electronic arrangement comprising at least one electronic device for implementing the present invention.

FIG. 3 is a flow diagram of an embodiment of a method in accordance with the present invention.

### DETAILED DESCRIPTION

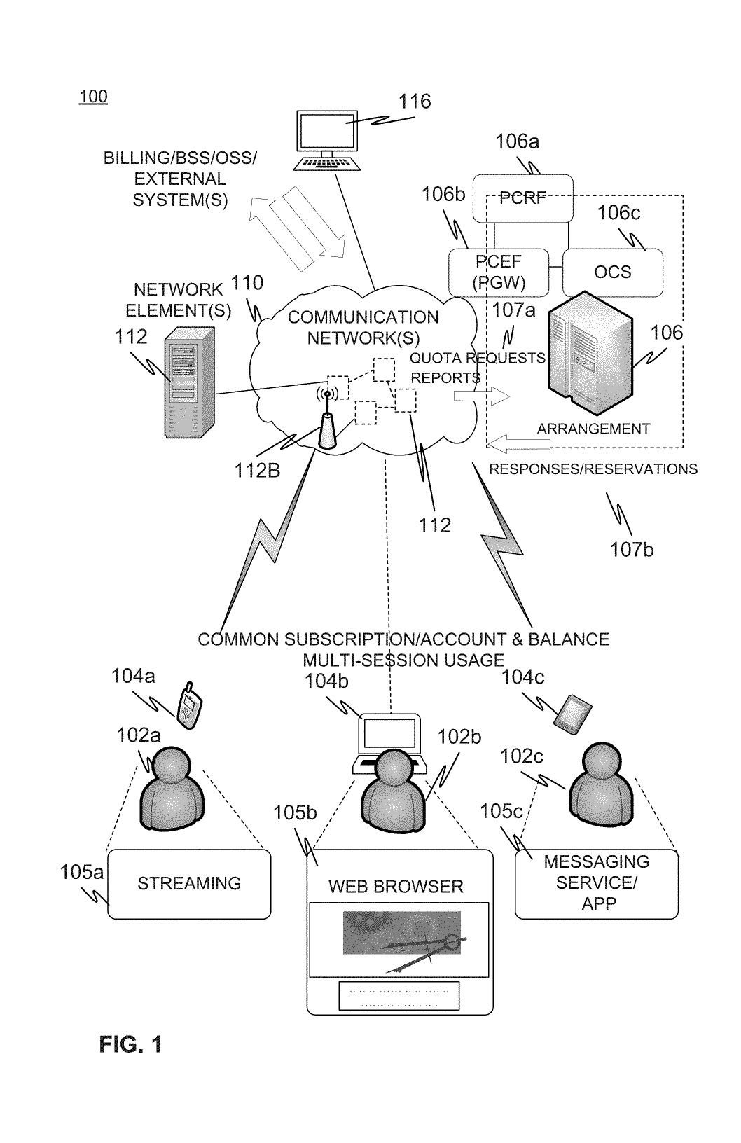

FIG. 1 illustrates an embodiment of an arrangement in accordance with the present invention and potential related use scenario.

Different embodiments of the present invention, such as the one depicted in FIG. 1, may indeed be utilized in a variety of network architectures and technologies, which include e.g. mobile networks of so-called 3G, 4G or 5G type, NFV (network function virtualization) based mobile networks, and/or hybrid networks incorporating features from both traditional (proprietary) mobile networks and NFV architecture.

Having regard to a practical example of available high performance wireless communication networks and technologies that may benefit from and also host embodiments of the present invention, e.g. Long Term Evolution (LTE) is a network scheme recommended by the 3^{rd} Generation Partnership Project (3GPP).

In an LTE network, all communication is, instead of more traditional circuit-switched connections, carried over an IP channel from user equipment (UE), via OFDM-based (Orthogonal Frequency Division Multiplexing) E-UTRAN (Evolved UMTS Terrestrial Radio Access Network) air interface, to an all-IP core called the Evolved Packet Core (EPC). The EPC is a multi-access core network that basically enables operators to provide a common packet core network for 3GPP radio access (LTE, 3G, and 2G), non-3GPP radio access (HRPD, WLAN, and WiMAX), as well as fixed access (Ethernet, DSL, cable, and fiber). Different interworking specifications have been issued by the 3GPP for the purpose.

The EPC thus provides gateway access to other networks, operator services, applications, the Internet, etc. while ensuring an acceptable Quality of Experience (QoE) and charging a subscriber for their particular network activity. Even though LTE is in many contexts referenced as 4G technology, the basic LTE does not as such completely fulfill the requirements originally set for 4G wireless service by ITU-R, whereupon it is often considered to fall under the “almost” 4G or “first generation 4G” category, whereas a more recent enhancement thereof named as LTE Advanced (LTE-A) meets the requirements more literally.

An embodiment of the arrangement suggested herein may be implemented as an entity, such as one or more (functionally connected) servers, which may be separate from (but functionally connected) or integrated with existing network entities such as one or more entities of an existing PCC (Policy and Charging Control) architecture. The PCC may be arranged to provision, manage and execute QoS and bandwidth control policies regarding applications and services, subscriber/subscription-aware policies, etc. in the network.

The PCC may comprise e.g. a Policy and Charge Rules Function (PCRF) entity intended for e.g. policy and charging management. The PCRF may have access to or comprise one or more subscriber databases. In particular, the PCRF may comprise or have access to a Subscription Profile Repository (SPR) including subscriber/subscription data such as indication of allowed services and/or QoS, charging information, category information, etc. The PCRF may be connected to an application function (AF) (provided e.g. in connection with Proxy-CSCF, Call Session Control Function) that is designed for interacting with applications/services requiring dynamic policy and charging control by extracting, for instance, session information from application signalling (e.g. identifier, address, bandwidth and media data) and serving the PCRF with it. Via the PCRF, service providers may charge subscribers based on their usage volume of high-bandwidth applications or limit application usage. In connection with 3G/UMTS (Universal Mobile Telecommunications System), PDF (Policy Decision Function) and CRF (Charging Rules Function) could be harnessed into similar use as the PCRF on the LTE/EPC side.

In practice, the PRCF can be considered as a functional element that encompasses policy control decision and flow based charging control functionalities. It may be configured to determine, decide and manage policies regarding subscriber's session or applications, and accordingly, instruct one or more relevant nodes to enforce them (e.g. one or more PCEF and/or TDF, traffic detection function), utilizing a number of PCC rules determined for the purpose. In making policy decisions, the PCRF may connect to the SPR and e.g. various provisioning systems.

The PCRF may utilize information on the subscriber's account/balance status in making policy decisions. The PCRF may thus request balance and balance consumption related reports including e.g. related counter statuses for policy control from external entities such as an OCS (Online Charging System) connected thereto.

Physically, the PCRF as well as many other network nodes reviewed herein, may be implemented as one or more (functionally connected) servers.

PCEF (Policy and Charging Enforcement Function) or similar entity may be provided to perform actual enforcing activities such as gating and QoS for IP flows having regard to the set policies. It may be implemented in connection with other/existing network nodes such as routers, gateways (e.g. GGSN (gateway GPRS support node), or P-GW (packet data network) gateway), and/or on a dedicated appliance. The network traffic to be controlled may then “naturally” flow via the PCEF. In addition, the PCEF entity may further be configured to detect application or data characteristics such as type of traffic carried by traffic (IP) flows such as calls, video, particular applications—relating traffic, etc. Yet, it may serve the PCRF with session information (e.g. subscriber location and/or identifier), which the PCRF may forward to further entities. In practice, PCEF may be configured to utilize a number of PCC rules for evaluating traffic (data packets).

For traffic detection and real-time enforcing of policies and e.g. related QoS activities on the traffic, the network may further include e.g. a Traffic Detection Function (TDF), which can detect and identify application traffic (call, video, etc.) in the traffic flows and inform the PRCF about the findings. The TDF may also be configured for policy enforcement, whereupon it reminds of the PCEF. The TDF may be integrated with other entities such as P-GW or implemented as a dedicated one.

Still, the aforementioned deep packet inspection (DPI) may be provided and included e.g. in the TDF and configured to identify data flows in real-time for policy enforcement.

Online control over the usage of network resources and e.g. related online charging refer to various processes where charging and/or usage information is collected in parallel with actual resource usage. Similar procedures take place in offline type of charging, but in connection with online control and online charging, authorization for the network resource usage shall be specifically obtained by the network prior to the usage of the resource. Such authorizations may be granted by e.g. OCS responsive to a request from the network. The OCS enables managing subscriber's/subscription's account (balance, charging) based on resource usage such as service usage in real time with reference to e.g. amount or volume (e.g. kilobytes or megabytes), time (often seconds or minutes), and/or events. Accordingly, the OCS may control the subscription's usage of resources (e.g. service delivery) and in extreme case terminate or prevent the usage, for instance, when the subscription-related account indicates that due to e.g. zero balance. The OCS may be thus cleverly applied to manage e.g. usage of prepaid class subscriptions such as pay-as-you-go type subscriptions.

The OCS may be practically provided using at least one server functionally connected to e.g. PCEF, TDF and/or PCRF, and configured to manage (limit or end, for example) subscriber's service usage in real-time based on monitoring and charging the account balance. Charging may be dependent on subscription details and e.g. transferred data volumes, connection duration, particular events, etc.

When receiving a network resource usage request initiated by a user or a network element, a particular network element in charge (see CTF below) may assemble the relevant charging information and generate a charging event towards the aforementioned OCS in real-time. The OCS then returns an appropriate resource usage authorization. The resource usage authorization may be limited in its scope (e.g. volume of data or duration); therefore the authorization may have to be renewed for continuing the usage of the resource.

A CTF (Charging Trigger Function) refers generally to a network node (network element) which will generate signaling such as charging events based on network resource consumption by a subscriber. Examples of network nodes which may contain a CTF include SGSN, P-GW (with e.g. PCEF), and ePDG (evolved Packet Data Gateway).

In one realization (LTE) of OCS, charging events from a CTF are particularly received by so-called Online Charging Function (OCF) of the OCS. The OCF may then decide about usage of resources based on Rating Function (RF) and Account Balance Management Function (ABMF). The OCS may allow, for instance, an entity such as the PCEF in connection with the CTF to enforce provision of related service or session based on time, traffic volume or chargeable events.

The RF may be utilized to determine the value/cost or generally the effect of events or other network resource usage on the subscription account balance (monetary/non-monetary as discussed herein) based on selected criteria including e.g. subscriber and/or balance information. The ABMF may be configured to host subscription account—associated balance data such as monetary and/or non-monetary data.

In various embodiments, where the arrangement of the present invention is utilized in connection with communication networks such as mobile networks, or specifically e.g. in the context of 4G or particularly LTE networks, quota reservation may be generally executed on event or session basis, for example, with reference to event charging with unit reservation (ECUR) and session charging with unit reservation (SCUR) procedures defined for the purpose instead of immediate (upfront) charging model, which is a third common model for online charging but omits unit reservation as its name implies. An online client (CTF) in connection with e.g. PCEF or generally a network element may request resource allocation from the OCS (or other quota reservations granting entity) and report credit control information to the OCS. For related communication, so-called Gy interface may be utilized between the OCS and PCEF.

In connection with ECUR, a network element (CTF) receives a service request indicative of a need to utilize network resources. The service request may have been originally initiated either by a user or other network element. The network element sends a (quota) reservation request for desired capacity units (monetary or non-monetary as discussed hereinelsewhere) to the OCS or other quota reservations granting entity, which determines whether the requested quota, some other quota, or no quota can be granted in return based on the quota reservation mechanism disclosed herein based on e.g. associated subscription balance and the active (in use) configuration of the mechanism.

RF or other applicable mechanism/entity may be applied in making the requested capacity as indicated in the request and subscription account such as balance data mutually comparable. For example, if the request indicates a need for data transfer capacity in terms of rate or amount type units, and the account data is of monetary type, the mechanism may be applied to convert e.g. the requested extent of quota as indicated in the request into monetary units, or vice versa. The outcome of the determination, such as authorization of service execution, is signaled to the requesting network element. Afterwards (after the content/service delivery), the network element may send at least one message indicative of termination of resource utilization (session termination, for instance) and/or including e.g. a report to the OCS indicative of the used capacity (units). Based on the actual/reported usage, the consumed portion of the granted quota (if not consumed fully) may be used to update the associated balance by subtracting the used portion of the quota reservation from current balance.

In connection with SOUR scenario, the action flow may turn out generally similar to above ECUR. However, during session delivery, the network element may a number of times send update requests to the OCS to report the unit usage and request further units, which the OCS then processes in accordance with an embodiment of the present by issuing further quota responsive to the request, if applicable, and answers to the network element.

With reference to the above description of various applicable network environments and related entities for carrying out different embodiments of the present invention, FIG. 1 illustrates, at 100, one merely exemplary network environment in connection of which an embodiment of the present invention may be implemented and utilized.

User devices (UE) 104a, 104b, 104c such as wired or wireless terminals, e.g. smartphones, tablets, wearable electronics devices, laptops or desktop computers, may be functionally connected to a communications network 110 comprising e.g. a mobile communications network by a suitable wireless transceiver. Users 102a, 102b, 102c utilize their respective UE's 104a, 104b, 104c for content and service delivery, such as streaming 105a (e.g. multimedia such as movies), web browsing (web content access) 105b, messaging and communication 105c, etc. Such usage consumes resources provided by the network 110, whereupon resource usage shall be subjected to an embodiment of the present invention for optimizing related quota reservations.

The users/devices referred to above may be associated with a common subscription (account), which may have a common balance for resource usage, and/or a single user/device may be associated with multiple simultaneous sessions, whereupon optimized quota allocation suggested herein may be considered particularly advantageous.

The network 110 may comprise one or more core networks, such as the EPC, and generally comprise a plurality of network elements 112 such as gateways, switches, registers, and/or other entities. The UE 104a, 104b, 104c may connect to the core network via a radio access network (RAN) 112B. The network 110 may comprise one or more access networks of optionally mutually different technologies, such as E-UTRAN radio access interface of LTE architecture or UTRAN radio access interface of 3G UMTS network. The network 110 and access network(s) 112B thereof may thereby comprise elements from several network technologies such as base stations eNodeB (LTE) and NodeB (3G/UMTS)

IP network or generally PDN (packet data network) may be utilized to connect different parts such as e.g. LTE and 3G sub-networks of the overall network architecture considered together.

Through the network environment and associated network elements such as gateways (e.g. P-GW), the UE's 104a, 104, 104c may further have access to other networks such as the internet 128 for e.g. content access therefrom. The network 110 may generally implement a number of connections to external systems 116, including e.g. various billing, OSS (operations support system), and/or BSS (business support system) systems. Note that e.g. OSS and BSS may be integrated in some use scenarios.

In some embodiments, a number of virtualization technologies such as NFV (network function virtualization) and generally cloud architecture may have been applied to virtualize at least some of the functionalities provided by the network 110. Yet, in some embodiments, SDN (software defined network) may have been applied to separate data and control planes thereof.

A plurality of further elements not separately depicted in FIG. 1 may also be comprised in the network, for instance one or more of the afore-reviewed policy control, traffic analysis and/or charging functionalities. The network may in addition to or instead of proprietary equipment comprise various NFV management, orchestration (MANO) and implementation related entities such as more generic servers to host virtualized network functions (NFV) on top of hypervisor-created virtual machines, managed by the MANO architecture.

As deliberated hereinbefore, the arrangement 106 in accordance with the present invention, processing quota requests and determining quota reservations in response therewith, may be implemented by means of one or more network elements integral with or at least operatively connected to the network 110. The arrangement 106 may comprise or be implemented (hosted) by the OCS 106c or an entity (e.g. a server) coupled thereto. Yet, the arrangement may comprise or be hosted by at least portion of PCRF 106a and/or PCEF 106b, or be at least operatively connected thereto.

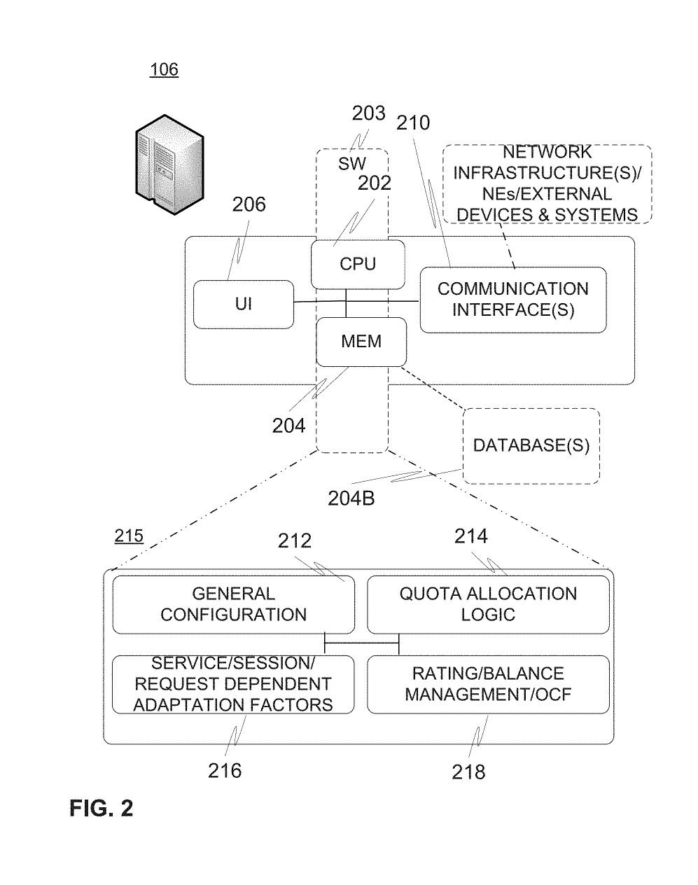

FIG. 2 depicts a block diagram representing the internals of an embodiment of the electronic arrangement 106 comprising at least one electronic device for implementing the present invention. As discussed hereinbefore, the arrangement 106 may be implemented e.g. in the OCS of the concerned network, or as an entity (e.g. via separate server) that is functionally connected thereto via applicable communication interface in between.

The arrangement 106 as well as most network elements or entities mentioned herein, such as the PCRF 106a or other policy control entity, preferably comprise one or more computing devices such as server devices, or alike, accessible via the communication network 110. At least one processing unit such as a microprocessor 202 may be included in the arrangement 106 and configured to execute the necessary determinations including calculations required for determining whether and to which degree quota requests received from network elements, with reference to aforementioned CTF-containing examples such as the P-GW, may be granted based on the related subscription account (balance) and reservation data as well as configuration data affecting the determination.

Various data such as program instructions (computer software program (product) 203), configuration data and/or data extracted from received requests may be hosted in a memory 204 with reference to a number of memory chips and/or hard disc(s), or generally provided on a non-transitory carrier medium such as memory card or transferred as a signal, for example. The data may be organized, besides in different programs, also in a number of databases 204B or other data structures, for instance. These structures may at least selectively or partially be of in-memory type for faster access. The memory 204 may further be at least partially integrated with the processing unit(s) 202.

For controlling and managing the operation of the arrangement 106, a user interface (UI) 206 may be provided. The UI may include local UI (e.g. display or other data output equipment and suitable control input equipment with reference to e.g. keyboard, touchscreen, mouse or other point-and-click device. Alternatively or additionally, remotely accessible UI may be provided, which may utilize e.g. communication adapter or communication interface of the arrangement 106, with reference to e.g. browser-accessible web based UI.

As alluded to above, for communication, the arrangement 106 may support one or more communication interfaces 210, by inclusion of compatible communication (interface) adapters such as transceivers operable in a target communication infrastructure, e.g. a wired network. The communication interface/adapter 210 may comply with a selected standard in accordance with the underlying or connected network characteristics. Via the communication interface 210 the arrangement 106 may be connected to the network 110 and related network elements.

In some embodiments, the arrangement 116 may at least partially reside in a cloud computing and/or virtualization environment, thereby enabling easy scalability of the associated computing, storage and/or communication resources.

In some embodiments, the mobile network incorporating or at least communicating with the arrangement 116 may be at least partially implemented by a selected network function virtualization (NFV) technology.

At 215, some potential elements or entities of the arrangement 106 are illustrated more from a functional standpoint. The arrangement 106 comprises the actual quota allocation algorithm logic 214, e.g. coded in computer software, for determining the quota allocations based on relevant account data such as remaining balance (initial overall quota (initial balance)−consumed quota (consumed portion of the balance)) and existing but not yet consumed (used) or considered as consumed, quota reservations, and configuration of the algorithm, which may incorporate general part 212 as well as more dedicated part(s) such as service, session, request and/or subscription (account) specific adaptation factors 216 to be discussed in more detail hereinafter.

Yet, depending on the embodiment the arrangement 106 may comprise various rating and balance management or determination functionalities 218 as offered by e.g. the aforementioned RF and ABMF.

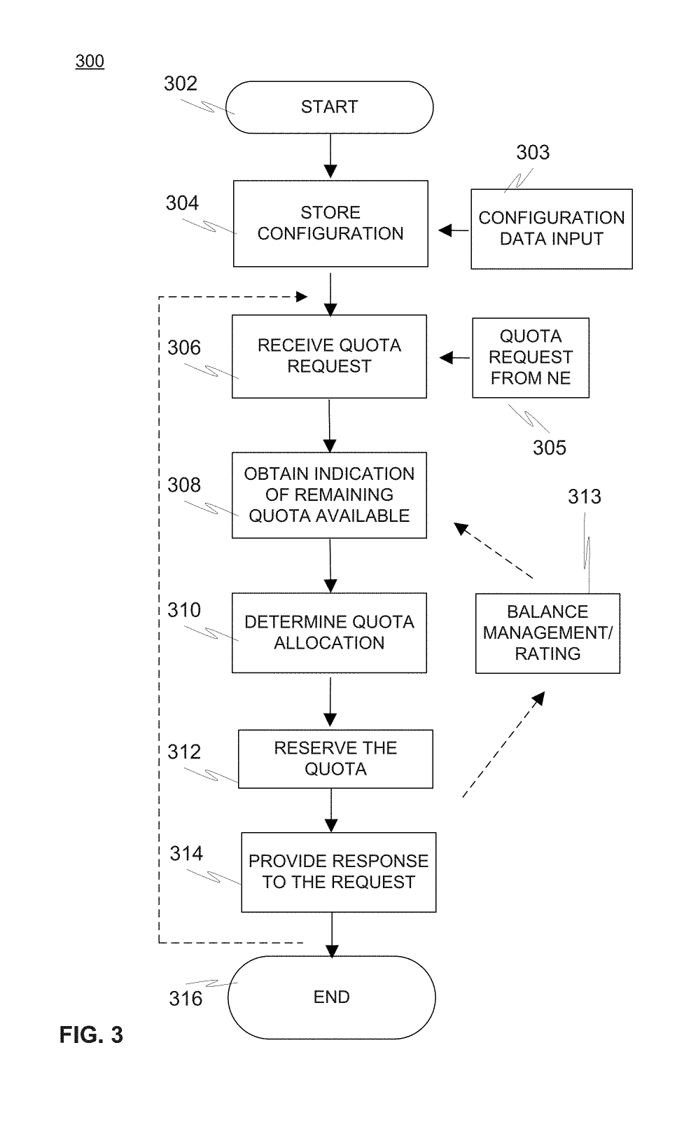

FIG. 3 is a flow diagram of an embodiment of a method in accordance with the present invention. At start-up 302, different initial preparatory tasks may be executed. An embodiment of the arrangement 106 for executing the method may refer to one or more servers optionally further implementing other functionalities such as the OCS and/or other functional entity of a target communication network, e.g. LTE or LTE-A compliant mobile network. The arrangement may be allocated with the necessary hardware and software (with reference to a number of servers, for example) and included in or at least connected to the target network infrastructure, e.g. as a part of an existing network element, or as a new one.

Item 303 refers to provision of necessary configuration input (data) to control the operation of the quota reservation mechanism suggested herein. The configuration data may originate e.g. from a number of other network elements such as the PROF or from an operator (entity or user), e.g. OSS/BSS system, which may reside external to the communication network whose resource allocation is controlled by the method.

At 304, the received configuration data is stored for subsequent use in quota determination. The data is optionally subjected to verification procedures that may be dynamically adjustable or preset.

The configuration data may be provided, stored and utilized in attribute-value pairs (AVP), for instance. Upon execution the quota management solution suggested herein may fetch applicable values from the configuration data and adjust its operation accordingly.

At 305, a quota reservation request is received from a network element. The request may have been originally initiated by a user (of user device) or other network element as deliberated hereinearlier. The request may incorporate an indication of a requested extent of quota e.g. as a related value of a message field or parameter. Alternatively, the indication could be received or retrieved external to the request.

At 306, the quota request is received and interpreted through parsing, for example, in accordance with the format or syntax of a message that the quota request should follow.

Item 308 refers to acquisition of a status indication regarding the concerned subscription's (account's) remaining (both unused and still unreserved) quota. As discussed hereinearlier, the remaining quota available for reservation can indeed be generally obtained by subtracting the existing quota reservations from the current balance, which thus equals to subtracting existing quota reservations and already consumed (used) balance (i.e. consumed quota) from the initial balance (i.e. from the initial overall quota available for use by the subscription/account per monitoring period, such as a month, or in general).

Depending on the embodiment, the arrangement may be able to determine or keep track of account balances and quota reservations completely autonomously (if it is integrated with the OCS and e.g. related RF and ABMF) or it may, to determine the remaining quota, request or fetch at least part of the required data from external entities/devices such as the RF or ABMF entities mentioned above.

Item 313 refers to a number of entities that may provide and/or receive and store information regarding the balance management, related calculations and/or quota reservations, the entities thus being internal or external to the arrangement.

At 310, the request is processed and quota reserved based on e.g. the account (balance) and reservation status, the request itself and relevant part of the configuration data. The request may be granted (i.e. quota reserved) as requested, to some other extent, or not at all, for example.

Next, one embodiment of the quota allocation mechanism is explained, by way of example only, using pseudo-code and related relevant configuration data.

The reservation mechanism may be utilized to guarantee that subscriber's account does have enough quota for usage, while the actual usage will be reported later.

Configuration parameters/variables directing the quota allocation may include e.g. one or more elements listed below:

MinR—Minimal extent, or “size”, of a reservation, in the concerned units (bytes, time, rate/speed, monetary, etc.); this may describe e.g. the absolute or preferred minimum if e.g. the target NE cannot operate with smaller values or smaller values do not generally make sense (granting one byte for data transfer is practically often useless, for instance);

RSF—Reservation multi-Session Factor, controls how early or radically the extent of the reservation is decreased depending on the number of potential or ongoing, parallel sessions or generally network resource utilization operations (greater the number, earlier/more radical decrease in the granted quota). This is preferably thus subscription account dependent variable and/or it may be made adaptive. E.g. “family subscription” may have 5 simultaneous possible sessions due to family members simultaneously engaging in such, or a single user may have e.g. messaging and (other) data services in use substantially simultaneously.

The value of the factor may be fixed or adapted dynamically based on e.g. history data and/or analytics of service/resources usage by the concerned user or generally subscription as in some cases even though the number of parallel sessions is high(er), the actual degree of network resources such as communication or specifically data transfer resources utilization remains relatively modest (in that case the factor could be adapted smaller, thus limiting the quota reservations less than with users/subscriptions that tend to heavily utilize resources in their each ongoing session);

AON (“all or none” or “all or nothing”) preference factor, e.g. AON flag—a reservation request preferably indicates if requested reservation extent can be altered, or specifically decreased, or not, if e.g. less than requested may appear useless to the requestor. For example, if for certain messaging, minimum amount is requested but a smaller extent granted, the allowed extent may be of no use at all. This may thus be e.g. service or request specific flag, or e.g. subscription (account) specific one. If ‘all’ is indicated, it may be translated into reduced (loosened) criteria in quota allocation, and vice versa;

(reservation factor) FLAG—may be utilized to indicate if reservation should be done even when there is no free quota (unused or unreserved quota left), which basically enables overbooking (still preferably limited by balance); and/or

MaxR—may define the maximum extent (size) allowed to be reserved if there is no free quota left, see also FLAG above, (where MinR<=MaxR), which thus indicates how high e.g. better user experience may be valued at the potential cost of overspending of the network resources from the standpoint of e.g. mobile network operator and/or communications services provider. Overbooking thus not necessarily always directly translate into overspending as the granted excessive reservations may remain unused.

Yet, a number of e.g. session and service dependent factors, such as traffic type, device type (e.g. IoT, internet-of-things, or other metering devices could be generally allocated smaller quotas than e.g. smartphones), and/or system load (if e.g. quota reservation encounters heavy load, larger quotas could be granted) could be taken into account in quota determination (however, omitted from the example below for clarity reasons).

Dynamic quota reservation could then generally proceed as shown in the pseudo-code type embodiment below. The pseudo-code has been written in a manner that renders it somewhat self-evident to a person skilled in the art but some additional remarks have been still provided using 7/′ marks and as separate comments below the code:

if(counter balance <= 0) //balance counter indicates the current balance, if not left at all -> no
grant
return REJECT_RESERVATION;
endif.
r.quota left = max(0, counter balance − existing counter reservations); //determine currently

//remaining, i.e. unused
//and unreserved quota

```
if(AON = true) //when AON is true, e.g. RSF is not used to limit the grant
  if(requested quota > counter balance)
  return REJECT_RESERVATION;
  endif.
  if(r.quota left = 0 or r.quota left < requested quota)
  if (FLAG = true and (requested quota − r.quota left <= MaxR))
    grant = max(requested quota, MinR); //determine and grant maximum of either input
  else
    return REJECT_RESERVATION;
  endif.
  else
  if(r.quota left < MinR and FLAG = true)
    grant = MinR;
  else if(r.quota left < MinR + max(requested quota, MinR))
    grant = r.quota left;
  else
    grant = max(requested quota, MinR)
  endif.
  endif.
else
  if(r.quota left = 0 and FLAG = false)
  return REJECT_RESERVATION;
  else if(r.quota left < MinR and FLAG = true)
  grant = MinR;
  else if(r.quota left < 2 * MinR)
  grant = r.quota left;
  else if(requested quota <= r.quota left / RSF)
  grant = max(requested quota, MinR);
  else
  grant = max(r.quota left / RSF, MinR);
  endif.
endif.
return min(grant, counter balance); // determine and grant minimum of either input
```

For example, the following border case decisions, as also indicated by the pseudo-code, may be thus selectively adopted by a preferred embodiment and realization of the present invention:
if counter balance is below 0, any new reservation request is rejected;
no reservation can be bigger than the current counter balance;
if counter doesn't have enough free quota for current reservation plus 1 more minimum size reservation, everything what is left is granted (incl. when AON is true); and/or
if the amount of free quota is smaller than minimum allowed reservation size and FLAG is False, the reservation request is not simply rejected but everything what is left can be granted.

Having regard to various potential notifications, the arrangement may be naturally configured to notify various entities such as network elements or systems when one or more predefined or adaptive limits are approached to a selected extent, met or exceeded.

A notification may be provided in a response to the quota request or using a separate message or separate signalling. For instance, an external element or system could be notified when the quota counter gets “close” to its limit (r.quota left/RSF<requested quota). This could in turn trigger actions such as provision of offer and e.g. possibility to execute a micropayment or allocate a microloan to the concerned user/subscription for continued service access.

Reverting to FIG. 3, at 312, quota reservation is made (if any) based on the determination result.

At 314, a related response optionally supplemented with a number of notifications, for example, is constructed and provided to the requestor. Also quota consumption reports may be received at this stage (not explicitly shown) for marking the reported portion of the reserved quota used (which may be reduced from the current balance to maintain it up-to-date) and releasing the reserved quota for further use, for example.

The method execution is ended at 316.

The dotted loopback arrow depicts the potentially repetitive nature of the execution of various method items. Besides handling of quota requests regarding different subscription accounts, several quota requests may well be received and processed in a row or at least every now and then having regard to a certain account. Also, the configuration 304 underlying the quota reservation mechanism could be updated either e.g. automatically responsive to internal analytics and adaptation engine or based on, optionally operator originated, control input.

In some embodiments, characteristics regarding e.g. overbooking such as its allowability and/or threshold (e.g. the above MaxR) may indeed be dynamically adapted based on e.g. predictive and/or other factor(s), such as an indication of estimated churn rating or score, which may be based on determined statistics, subscription matching and/or extrapolation. For instance, when the indicator indicates a high risk account/user in terms of abandoning the subscription, more overbooking may be allowed, and vice versa.

In some embodiments, additional quota or balance could be obtained via a micropayment or micro loan (microcredit) feature, which could be integrated with the arrangement of the present invention or provided as at least partially external system or entity operatively connected to the arrangement. The “micro” refers to somewhat modest extent of related payment/credit and related effect in the balance. It may, for example, correspond just to a minor portion of initial balance. A user or entity associated with a subscription could be provided with a notification message when the remaining balance or e.g. remaining (free) quota of the account decreases below a limit, which may be optionally adaptive. Responsive to the message (e.g. a text message or in-app message via an appropriate SDK (software development kit), for example, towards a (mobile) terminal) or independently, the user could then accept and trigger a micropayment or micro loan procedure via the UI of the user device to enable continuing the use of the concerned (network) resources beyond the original limit. Alternatively, e.g. a micro loan could be granted automatically based on a fulfillment of a number of related criteria. A person skilled in the art will realize that micro loan feature may at least partially overlap with the overbooking feature in terms of its implications.

In some embodiments, the RSF, i.e. Reservation multi-Session Factor, could further be made adaptive not only on current number of ongoing sessions or e.g. account type. It could also be made dependent on subscription/account usage history, via e.g. a related bias, preferably taking e.g. the time spent with each configuration of simultaneous sessions and/or usage extremes into account. For example, temporary rare or one-time peak of massive amount of simultaneous sessions would not translate into massive bias in RSF factor if the subscription is typically (e.g. most of the time) associated with very limited number of sessions/resource usage only.

In some embodiments, rounding may be applied to different determinations such as quota allocation and/or balance management in general. Rounding may be based on e.g. available or selected processing or storage resolution of concerned elements.

In some embodiments, one or more timers may be associated with quota reservations and utilized for related control tasks. For example, if appropriate usage report or acknowledgement is not received having regard to a quota reservation responsive to a query or in accordance with a predefined schedule, the quota reservation made may be cancelled.

In some embodiments, AON flag and underlying all-or-nothing control mechanism is not necessarily implemented but still overbooking related mechanisms and elements such as FLAG and/or MaxR are. The same applies to RSF/multi-Session Factor type control. In other words, these mechanisms and related elements could be selectively, or independently, adopted in various use scenarios, although being clear to a person skilled in the art that they also have synergetic effects in favor of user experience, whereupon many preferred embodiments utilize several if not all of them.

1. An electronic arrangement for dynamically reserving quota having regard to the capacity of one or more resources available in a communications network, comprising one or more data interfaces such as transceivers for transferring data, at least one processor for processing instructions and other data, and memory for storing the instructions and other data, said at least one processor being configured, in accordance with the stored instructions, to cause:
receiving a quota request, such as a signaling message, with indication of a requested extent of quota, wherein the quota request is further associated with all-or-none preference indicator as to whether the request should be fulfilled completely,
obtaining an indication of a currently remaining, unused and unreserved, quota of an account associated with the quota request,
determining whether and to which degree, including in full, in part and not at all, the request may be granted in terms of reserving the requested quota based on at least the requested extent, the remaining quota and the preference indicator, wherein the indicator is utilized in the determination so that indicated preference on complete fulfillment of quota request translates into reduced criterion in quota allocation and vice versa, and
providing a response to the quota request indicative of extent of granted, reserved quota, if any, where the response is optionally conveyed via a signaling message, and wherein the arrangement is configured to overbook the remaining quota associated with the account in terms of one or more reservations so as to allow reservations going beyond the remaining quota by a selected amount.

2. The arrangement of claim 1, wherein the extent of granted quota having regard to the requested resources is determined or indicated in terms of at least one element selected from the group consisting of: time, seconds, minutes, days, months, data rate, number of events, number of service accesses, number of downloads, and amount or volume of data optionally in kilobytes, megabytes, gigabytes, or terabytes.

3. The arrangement of claim 1, wherein the selected amount is at least responsive to a state of an overbooking indicator indicate of whether overbooking is allowed or not.

4. The arrangement of claim 1, configured to determine to the quota reservation based on a multi-session variable indicative of a number of parallel quota consuming sessions associated with the account.

5. The arrangement of claim 4, wherein a greater number of sessions translates into a reduced extent of granted quota, and vice versa.

6. The arrangement of claim 1, configured to determine the quota reservation based on a predefined minimum reservable quota that defines a default minimum size of the quota reservations.

7. The arrangement of claim 6, configured to grant the remaining quota responsive to the request if the remaining quota is smaller than the minimum reservable quota and overbooking of quota in terms of one or more reservations is not allowed.

8. The arrangement of claim 6, configured to grant the minimum reservable quota responsive to the request if the remaining quota is smaller than the minimum but overbooking of quota in terms of one or more reservations is allowed.

9. The arrangement of claim 6, configured to grant the remaining quota responsive to the request when the remaining quota does not cater for the requested extent plus one more minimum reservable quota.

10. The arrangement of claim 1, configured to reject the request completely by omitting any grant of quota if current balance associated with the account, defined by unused quota, is zero or less.

11. The arrangement of claim 1, configured to transmit a notification message informing a recipient, optionally external system and/or a user associated with the account, of the remaining balance or free quota approaching, hitting, or exceeding a selected limit, wherein the arrangement is optionally further configured to offer micropayment or micro loan to the user to enable the user to continue utilizing the resources beyond the original limit.

12. The arrangement of claim 1, comprising a translation mechanism configured to convert or otherwise process the data in the request indicative of the requested extent of quota to make it commensurate with available, account related data regarding the remaining quota and/or balance of the subscription account.

13. A method for dynamically reserving quota having regard to the capacity of one or more resources available in a mobile communications network, comprising:
receiving a quota request with indication of a requested extent of quota, wherein the quota request is further associated with all-or-none preference indicator as to whether the request should be fulfilled completely,
obtaining an indication of a currently remaining, unused and unreserved, quota of an account associated with the quota request,
determining whether and to which degree, including in full, in part and not at all, the request may be granted in terms of reserving the requested quota based on at least the requested extent, the remaining quota and the preference indicator, wherein the indicator is utilized in the determination so that indicated preference on complete fulfillment of quota request translates into reduced criteria in quota allocation and vice versa, and
providing a response to the quota request indicative of extent of granted, reserved quota, if any, and wherein the arrangement is configured to overbook the remaining quota associated with the account in terms of one or more reservations so as to allow reservations going beyond the remaining quota by a selected amount.

14. A computer program comprising code means adapted, when run on a computer, to execute method items of claim 13.

15. A non-transitory carrier medium carrying the program of claim 14.

16. The arrangement of claim 3, configured to determine to the quota reservation based on a multi-session variable indicative of a number of parallel quota consuming sessions associated with the account.

17. The arrangement of claim 16, configured to determine to the quota reservation based on a predefined minimum reservable quota that defines a default minimum size of the quota reservations.

18. The arrangement of claim 17, configured to grant the remaining quota responsive to the request if the remaining quota is smaller than the minimum reservable quota and overbooking of quota in terms of one or more reservations is not allowed.
